(19) United States
(12) Patent Application Publication
(10) Pub. No.: US 2012/0174237 A1
(43) Pub. Date: Jul. 5, 2012

(54) LOCATION AWARE SELF-LOCKING SYSTEM AND METHOD FOR A MOBILE DEVICE

(75) Inventor: Paul Krzyzanowski, Flemington, NJ (US)

(73) Assignee: OPENPEAK INC., Boca Raton, FL (US)

(21) Appl. No.: 12/983,127

(22) Filed: Dec. 31, 2010

(51) Int. Cl. G06F 21/00

(52) U.S. Cl. 726/29

(57) ABSTRACT

A mobile device includes a protected mode in which the device automatically locks itself after a period of inactivity. In the protected mode, the device can determine whether it is in a trusted location. If the device is not in a trusted location, the device continues in the protected mode. If the device is within a trusted location, the device can alter the protected mode, such as by disabling the protected mode. Alternatively, a parameter associated with the protected mode can be changed. For instance, the period of inactivity before the device automatically self locks can be increased. The trusted location can be defined by a specific network, specific wireless access point, specific geographic coordinates or an express user indication. Such a device can avoid the frustration of repeatedly locking and unlocking the device if the user is located in an environment in which privacy and security concerns are minimized.

### FIELD

Embodiments relate in general to mobile devices and, more particularly, to mobile devices that have self-locking systems.

### BACKGROUND

Mobile devices (i.e., smart phones, cellular phones, tablet computers, laptop computers, etc.) are ubiquitous in modern society. Due to security and privacy concerns, many of such mobile devices include a self-locking feature in which the device automatically locks itself after a period of inactivity, thereby preventing or at least impeding unauthorized access to the device. Some form of authentication (i.e., password or biometrics) is required to unlock the device.

Self-locking systems are typically an all-or-nothing approach; that is, the device is either set to self-lock or not. However, there are some environments where security and privacy concerns are significantly minimized. In such environments, the locking and unlocking of the device can be an annoyance, particularly if such actions have to be repeated. Thus, there is a need for a system and method that can minimize such concerns.

### SUMMARY

In one respect, embodiments are directed to a method for operating a mobile device in a trusted location. The mobile device has a processor. The mobile device has a protected mode in which the device automatically locks itself after a period of inactivity and an unprotected mode in which the device does not lock itself. When the device is in the protected mode, the method comprises determining whether the device is in a trusted location, and altering the protected mode of the device if the device is determined to be in a trusted location. Such steps can be performed at least partially via the processor.

The altering step can include disabling the protected mode of the device. Such a step can be performed via the processor. Alternatively, the altering step can include changing a parameter of the protected mode. Such a step can be performed via the processor. In one embodiment, the parameter is the period of inactivity that causes the device to automatically lock itself. In such case, the step of changing a parameter can include increasing the period of inactivity.

The trusted location can be defined in one or more ways. For instance, the trusted location can be defined by a predetermined set of trusted networks. In such case, the determining step can include the steps of identifying a network to which the device is connected, and comparing the identified network to the predetermined set of trusted networks. If the identified network is included in the predetermined set of trusted networks, then the device is determined to be in a trusted location.

In one embodiment, the trusted location can be defined by a predetermined set of trusted wireless access points. In such case, the determining step can include the steps of identifying a wireless access point to which the device is operatively connected, and comparing the identified wireless access point to the set of predetermined trusted wireless access points. If the identified wireless access point is included in the predetermined set of trusted wireless access points, then the device is determined to be in a trusted location.

In another embodiment, the device can include a positioning system. Any suitable positioning system can be used, including, for example, a global positioning system, local positioning system or a geolocation system. The trusted location can be defined by a predetermined set of trusted geographic locations. In such case, the determining step can include the steps of determining the geographic location of the device via the positioning system, and comparing the determined geographic location of the device to the predetermined set of trusted geographic locations. If the determined geographic location is within the predetermined set of trusted geographic locations, then the device is determined to be in a trusted location.

In still another embodiment, the trusted location can be defined by a user input. In such case, the determining step can include the step of determining whether a user has indicated that the device is in a trusted location. If the user has indicated that a location, such as his or her present location, is a trusted location, then the device is determined to be in a trusted location.

In yet another embodiment, the device can further include a sensor configured to detect unidirectional signals, such as may emanate from a signal beacon. In such case, the trusted location can be defined by a predetermined set of trusted unidirectional signals. The determining step can include comparing a unidirectional signal received by the sensor to the predetermined set of trusted unidirectional signals. If the received unidirectional signal is included in the predetermined set of unidirectional trusted signals, then the device is determined to be in a trusted location.

In some instances, the device can further include a transmitter for transmitting signals and a sensor configured to detect signals responsive to said signals from the transmitter, such as may be emitted from a transponder. In such case, the method can further include the steps of: transmitting a signal from the transmitter and comparing a signal received by the sensor in response to the signal in the transmitting step to a predetermined set of trusted signals. If the received signal is included in the predetermined set of trusted signals, then the device is determined to be in a trusted location.

The device can include a sensor configured to detect physical contact with the device. When the device includes such a capability, the trusted location can be defined by a predetermined set of trusted physical contact conditions. In such case, the determining step can include the steps of: detecting a physical contact condition with the device and comparing the detected physical contact condition to the predetermined set of trusted physical contact conditions. If the detected physical contact condition is included in the predetermined set of trusted physical contact conditions, then the device is determined to be in a trusted location.

In another respect, embodiments are directed to an electrical device. The device has a protected mode in which the device automatically locks itself after a period of inactivity and an unprotected mode in which the device does not lock itself. The device includes a processor configured to determine whether the device is in a trusted location and alter the protected mode of the device if the device is determined to be in a trusted location.

There are various ways in which the altering step can be performed. For example, the protected mode can be disabled, or a parameter associated with the protected mode can be changed, such as the length of the period of inactivity before the device locks itself. The altering step can be performed by the processor.

The trusted location can be defined in various ways. For instance, the trusted location can be defined by a predetermined set of trusted networks. In such case, in the determining step, the processor is configured to identify a network to which the device is operatively connected. The processor can compare the identified network to the predetermined set of trusted networks. If the identified network is included in the predetermined set of trusted networks, then the device is determined to be in a trusted location.

Alternatively, the trusted location can be defined by a predetermined set of trusted wireless access points. In such case, in the determining step, the processor is configured to identify a wireless access point to which the device is operatively connected, and compare the identified wireless access point to the set of predetermined trusted wireless access points. If the identified wireless access point is included in the predetermined set of trusted wireless access points, then the device is determined to be in a trusted location.

In some embodiments, the device can include a positioning system, which can be a global positioning system, a local positioning system or a geolocation system. The trusted location can be defined by a predetermined set of trusted geographic locations. In some instances, the geographic locations can be defined by geographic coordinates or a specified radius about particular geographic coordinates. In the determining step, the positioning system can be configured to determine the geographic location of the device. The determined geographic location of the device can be compared to the predetermined set of trusted geographic locations, such as by the processor. If the geographic locations determined by the positioning system are within the predetermined set of trusted geographic locations, then the device is determined to be in a trusted location.

In some cases, the trusted location can be defined by a user input. In such case, in the determining step, the device can determine whether a user has indicated that the device is in a trusted location. Such a determination can be made by the processor.

The device can further include a sensor for detecting signals. In such case, the trusted location can be defined by a predetermined set of trusted signals. If a signal received by the sensor is included in the predetermined set of trusted signals, then the device is determined to be in a trusted location. The signals may come from any suitable source, including a signal beacon or a Near Field Communication (NFC) source.

The device can further include a transmitter for transmitting signals and a sensor configured to detect signals responsive to the signals from the transmitter. If a signal received by the sensor is included in a predetermined set of trusted signals, then the device is determined to be in a trusted location. Signals responsive to the signals from the transmitter may be generated by a transponder.

The device can further include a sensor configured to detect physical contact with the device. If a physical contact condition with the device is detected by the sensor and if the physical contact condition is included in a set of trusted physical contact conditions, then the device is determined to be in a trusted location.

### BRIEF DESCRIPTION OF THE DRAWINGS

FIG. 1 is a diagrammatic view of a mobile device.

FIG. 2 shows a location aware locking method for a mobile device in which a trusted location is determined with respect to a network or wireless access point to which the mobile device is operatively connected.

FIG. 3 shows a location aware locking method for a mobile device in which a trusted location is a determined with respect to an input received by a sensor of the mobile device.

FIG. 4 shows a location aware locking method for a mobile device in which a trusted location is determined with respect to the geographic location of the mobile device.

FIG. 5 shows a location aware locking method for a mobile device in which a trusted location is determined by a direct setting inputted by a user.

### DETAILED DESCRIPTION

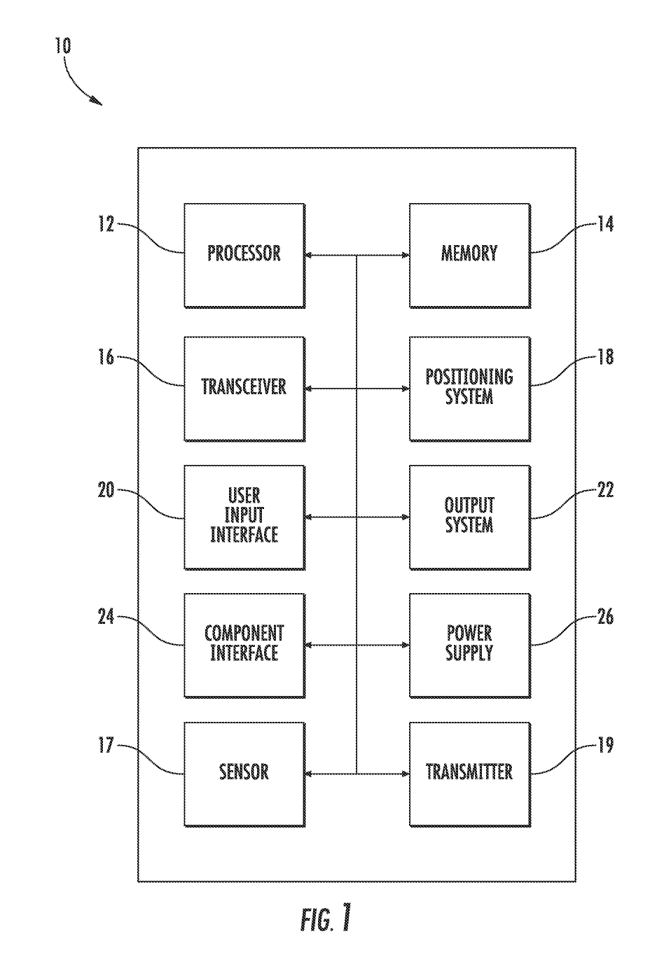

Arrangements described herein relate to a location based self-locking system and method for a mobile device. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Arrangements are shown in FIGS. 1-5, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an exemplary mobile device 10 is shown. The mobile device 10 can be any suitable device including, for example, a cellular telephone, a smart phone, a personal digital assistant (“PDA”), a tablet computer, a digital reader, a handheld device having wireless connection capability, a computer (e.g., a laptop), a portable communication device, a portable computing device, an entertainment device (e.g., a music or video device, or a satellite radio), a global positioning system device, a digital audio player (e.g., MP3 player), an e-book reader, a camera or a game console. In some instances, the mobile device 10 can be configured to communicate via a wireless or wired medium. However, the mobile device 10 is not limited to devices with such capability, as the mobile device 10 may not be configured to communicate via a wireless or wired medium. Embodiments described herein can be implemented into any suitable mobile device, including any of those listed above. The device 10 can include any suitable operating system.

Some of the various possible elements of the exemplary mobile device 10 shown in FIG. 1 will now be described. It will be understood that it is not necessary for a mobile device 10 to have all of the elements shown in FIG. 1 or described herein. The mobile device 10 can include a processor 12. The processor 12 may be implemented with one or more general-purpose and/or special-purpose processors. Examples of suitable processors 12 include microprocessors, microcontrollers, DSP processors, and other circuitry that can execute software. The mobile device 10 can include memory 14 for storing various types of data. The memory 14 can include volatile and/or non-volatile memory. Examples of suitable memory 14 may include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The memory 14 can be operatively connected to the processor 12 for use thereby. The term “operatively connected” can include direct or indirect connections, including connections without direct physical contact.

As will be described in greater detail later, the device 10 can be configured to determine whether it is in a trusted location. In some instances, such a determination can be made at least in part by the processor 12. The device 10 can include one or more inputs to support such a determination. A “trusted location” is defined as any area, space, environment or structure in which security concerns for a mobile device or other electrical device, including the threat of theft and/or unauthorized access or use of the device, are minimal.

For instance, a trusted location can be determined with respect to the network or wireless access point to which the device 10 is operatively connected. In such case, the device 10 can include a transceiver 16. The transceiver 16 can be operatively connected to the processor 12 and/or the memory 14. In one embodiment, the transceiver 16 can be a wireless transceiver. Any suitable wireless transceiver can be used to wirelessly access a network or access point for the transmission and receipt of data. The transceiver 16 may use any one of a number of wireless technologies. Examples of suitable transceivers include a cellular transceiver, a broadband Internet transceiver, a local area network (LAN) transceiver, a wide area network (WAN) transceiver, a wireless local area network (WLAN) transceiver, a personal area network (PAN) transceiver, a body area network (BAN) transceiver, a WiFi transceiver, a WiMax transceiver, a Bluetooth transceiver, a 3G transceiver, a 4G transceiver, a ZigBee transceiver, a WirelessHART transceiver, a MiWi transceiver, an IEEE 802.11 transceiver, an IEEE 802.15.4 transceiver, or a Near Field Communication (NFC) transceiver, just to name a few possibilities. The transceiver 16 can include any wireless technology developed in the future. In other exemplary embodiments, the device 10 may include one or more additional wireless transceivers (not shown) for accessing further wireless networks not accessible using the wireless transceiver 16. While much of the above discussion concerned a wireless transceiver, it will be understood that embodiments are not limited to wireless transceivers. Indeed, the transceiver 16 or an additional transceiver may be configured for wired network connections.

Alternatively or in addition to determining trusted locations based on network or access points, the device 10 can be configured to detect a trusted location with respect to an input received by the device 10. The input can include unidirectional communications from an external source. Accordingly, the device 10 can include a sensor 17. Any suitable sensor can be used depending on the input.

In one embodiment, the sensor 17 can be a signal sensor that can detect signals from a Near Field Communication (NFC) source or other source, such as a beacon or transponder. Any suitable type of signal can be detected. For instance, the sensor 17 can be adapted to detect specific radio frequency (RF) signals. In such case, the sensor 17 can be adapted to detect RF signals emanating from a signal beacon or transponder. The sensor 17 can receive such RF signals if the device is located sufficiently proximate thereto. Again, RF signals are provided merely as an example, as the sensor 17 can be adapted to detect other types of signals. For example, the sensor 17 can be configured to detect humidity or temperature levels, altitude, various light wavelengths (including visible or non-visible), various frequencies of sound (including audible or non-audible to humans), motion or any other suitable type of parameter or phenomena.

In addition to the sensor 17, the device 10 may also include a signal transmitter 19. In such case, the device 10 itself can act like a signal beacon, as signals can emanate from the signal transmitter. The signal transmitter 19 can be adapted to produce signals that cause one or more specific transponders to respond. Thus, if the device 10 is located sufficiently close to a transponder, then the transponder can send a response, which can be received by the sensor 17.

In another embodiment, the sensor 17 may be a contact-based sensor. Thus, when the device 10 is contacted, it can be detected by the sensor 17. Certain contact may occur in a unique form, such as a particular pattern of contact locations or a particular pressure profile, thereby providing an indication of the location of the device 10. For instance, when the device 10 is engaged with a docking station, the device 10 may contact the docking station in specific locations or in a specific combination of locations, which the device 10 can be configured to recognize as a docking station.

In some implementations, the device 10 may be configured to detect a trusted location with respect to the physical location of the device 10. In some embodiments, the device 10 can include a positioning system 18. The positioning system 18 can be configured to monitor and/or determine the current geographic position of the device 10. The positioning system 18 can be any suitable type of positioning system, including, for example, a global positioning system, a local positioning system or a geolocation system. The positioning system 18 may be implemented with any one of a number of satellite positioning systems, such as the United States Global Positioning System (GPS), the Russian Glonass system, the European Galileo system, the Chinese Beidou system, or any system that uses satellites from a combination of satellite systems, or any satellite system developed in the future, including the planned Chinese COMPASS system and the Indian Regional Navigational Satellite System.

Alternatively or in addition, the positioning system 18 can be based on access point geolocation services, such as using the W3C Geolocation Application Programming Interface (API). With such a system, the location of the device 10 can be determined through the consulting of location information servers, including, for example, Internet protocol (IP) address, Wi-Fi and Bluetooth Media Access Control (MAC) address, radio-frequency identification (RFID), Wi-Fi connection location, or device GPS and Global System for Mobile Communications (GSM)/code division multiple access (CDMA) cell IDs. Thus, it will be understood that the specific manner in which the geographic position of the device 10 is determined will depend on the manner of operation of the particular positioning system 18 used.

The mobile device 10 can include a user input interface 20 for receiving input from a user. Any suitable user input interface 20 can be used, including, for example, a keypad, display, touch screen, button, joystick, mouse, microphone or combinations thereof. The user input interface 20 can be equipped to facilitate user authentication for unlocking the device 10. For example, the user input interface 20 can include a keyboard, touch screen and/or a keypad to allow for the entry of passwords, pass codes and/or personal identification numbers (PINs). Alternatively or in addition, the user input interface 20 can include a camera or scanner for facial and/or iris recognition. The user input interface 20 may include a fingerprint sensor. The user input interface 20 can include a display sensor for entering items or drawing patterns on the display.

The mobile device 10 can include an output system 22 for presenting information to the user. The output system 22 can include a general-purpose display, such as an LCD display, display port, a dedicated display (e.g., LCD message or icon that turns on and off). Alternatively or in addition, the output system 22 can include status lights or indicators to indicate that the device 10 is locked. Alternatively or in addition to any of the above, the output system 22 may include a printer. Alternatively or in addition to any of the above, the output system 22 may include an audio interface that can include a microphone, earphone and/or speaker.

The mobile device 10 may optionally include a component interface 24. Additional elements can be operatively connected to the component interface 24, including, for example, a universal serial bus (USB) interface or an audio-video capture system. The mobile device 10 may include a power supply 26. As is shown in FIG. 1, the processor 12, the memory 14, the transceiver 16, the sensor 17, the positioning system 18, the user input interface 20, the output system 22, the component interface 24 and/or the power supply 26 can be operatively connected in any suitable manner.

The mobile device 10 can have an unprotected mode and a protected mode. In the unprotected mode, the mobile device 10 does not automatically lock itself. Consequently, the mobile device 10 may be accessible to anyone who may handle the device. In the protected mode, the mobile device 10 can automatically lock itself after a period of inactivity. “Lock” means that at least one function of the device becomes substantially unusable or disabled unless and until authentication is provided. Any suitable type of authentication may be required to unlock the mobile device 10, including the forms described above in connection with the user input interface 20.

Embodiments herein are directed to instances in which the protected mode may be altered, as will be described below, when the mobile device 10 is located in a trusted location. A trusted location can be determined by the user. The user can input a predetermined set of trusted locations. The set of trusted locations can include at least one trusted location. A trusted location can be defined in any suitable way. Various implementations of systems and methods herein will be presented in turn below, along with examples of a trusted location.

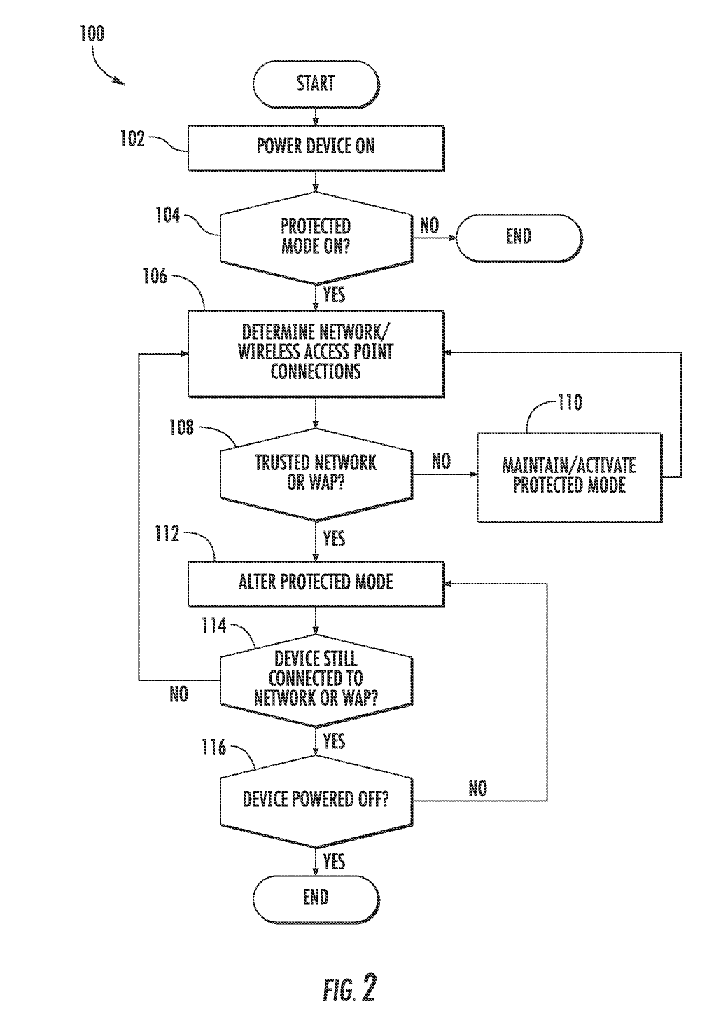

In one embodiment, the trusted location can be defined by a specific network or a specific wireless access point (WAP). Thus, the trusted locations can be a set of one or more networks and/or wireless access points. Referring to FIG. 2, an exemplary location aware self-locking method 100 is shown in which a trusted location is defined by a specific network and/or a specific WAP. The term “network” is defined as one or more components designed to transmit or receive information to or from one source to another and includes networks that are centrally coordinated or those operating in a peer-to-peer fashion. The transmission can be achieved in any suitable manner, such as by a hardwire connection or wirelessly. “Wireless access point” means any device that allows a mobile devices to wirelessly connect to a network.

The user can configure the device 10 so that one or more specific networks and/or one or more specific WAPs are identified as trusted locations. The trusted networks or WAPs can be identified and/or inputted by the user in any suitable manner. For instance, the user can manually identify one or more networks and/or WAPs that are to be considered trusted locations. Alternatively or in addition, any time the user connects to a network or WAP, the device 10 can prompt the user as to whether he or she wishes to add this network or WAP as a trusted location. The user can identify the trusted networks or WAPs using the user input interface 20.

There are still other possible ways to identify and/or specify a trusted network and/or WAP. For a wired or a wireless network, the Media Access Control (MAC) address of the gateway or router can be used. Alternatively, a server on a well-known address within a local area network (LAN) can be contacted. Still alternatively, a service discovery protocol, such as zero configuration networking (Zeroconf) or Bonjour available from Apple Inc., can be used to locate an authentication service on a local area network (LAN). Furthermore, within a wireless network, the service set identifier (SSID) of a network can be used. For greater security, the basic service set identifier (BSSID) of the access point can be used. For non IEEE 802.11-based wireless networks, the equivalent of the network controller's MAC address can be used.

With these examples in mind, various possible steps of method 100 will now be described. The method 100 illustrated in FIG. 2 may be applicable to the embodiments described above in relation to FIG. 1, but it is understood that the method 100 can be carried out with other suitable systems and arrangements. Moreover, the method 100 may include other steps that are not shown here, and in fact, the method 100 is not limited to including every step shown in FIG. 2. The steps that are illustrated here as part of the method 100 are not limited to this particular chronological order, either.

In step 102, the mobile device 10 is powered on. In decision block 104, the mobile device 10 can determine whether the protected mode has been activated. If the protected mode has not been activated, then no further action may be taken. However, the device 10 may continuously, periodically or randomly return to step 104, as the user may subsequently activate the protected mode of the device 10.

If the protected mode is activated, then, in step 106, the device 10 can determine whether it is operatively connected to a network and/or a WAP. The device 10 can also identify any networks or WAPs to which the device is operatively connected. In decision block 108, the device 10 can determine whether it is in a trusted location, that is, whether it is connected to a trusted network and/or WAP. The device 10 can compare the network and/or WAP identified in step 106 to the predetermined set of trusted networks or WAPs, as previously identified by the user or some other suitable entity. If the network or WAP identified in step 106 is not included in the predetermined set of trusted networks or WAPs, then the network or WAP identified in step 106 is determined to be a non-trusted location. As a result, the protected mode of the device 10 can be maintained in step 110. In such case, the device 10 may continuously, periodically or randomly return to step 106 to determine current network or WAP connections, as such connections may have changed. In some instances, the device 10 may be connected to a plurality of networks and/or a plurality of WAPs. In such case, the method 100 can proceed to step 110 if at least one of the plurality of networks or WAPs identified in step 106 is determined to be a non-trusted network or WAP.

If the network and/or WAP identified in step 106 is included in the predetermined set of trusted networks or WAPs, then the network or WAP identified in step 106 is determined to be a trusted location. As a result, the device 10 can alter the protected mode in step 112. In one embodiment, step 112 can comprise deactivating the protected mode. In such case, the device 10 can effectively operate in the unprotected mode until the device 10 is no longer connected to a non-trusted network or WAP or until the user indicates otherwise. Alternatively, step 112 can comprise changing a parameter associated with the protected mode. One example of such a parameter is the period of inactivity that triggers the automatic locking of the device in the protected mode. This parameter can be changed. For example, if the period of inactivity is set for a certain amount of time, then that period of time can be increased by a predetermined multiple. Alternatively, the device 10 can be configured so that the period of inactivity is increased to a predetermined amount of time that is greater than the current period of inactivity. As an example, if the device 10 is configured to initiate the protected mode after 5 minutes of inactivity, then the period of inactivity can be increased to one hour if the device is connected to a trusted network or WAP.

In decision block 114, the device 10 can determine whether it is still connected to the trusted location previously identified in step 106. If it is, then the device 10 can continue to step 116, where it is determined whether the device 10 has been powered off. If the device 10 is still powered on, the method 100 can return to step 112, where the altered protected mode can continue. If the device 10 is powered off, the method 100 can be terminated.

If, in decision block 114, the device 10 determines that it is no longer connected to the trusted network or WAP previously identified in step 106, then the method 100 can return to step 106 in which the device 10 can determine and identify the networks and/or WAPs to which the device 10 is operatively connected. The method 100 can continue as described above. If the device 10 is connected to a non-trusted network and/or WAP, then the protected mode can be restored; that is, the altered protected mode can be discontinued and the standard settings for the protected mode can be implemented.

It will be understood that the details of method 100 are exemplary, as some embodiments may include additional or fewer steps than those described above. For example, in some instances, the determination outlined in decision block 114 may not be performed. Instead, if the device 10 is in the altered protected mode from step 112, then the device 10 can proceed to decision block 116. If the device 10 is not powered off, then the device 10 can periodically or continuously return to step 106.

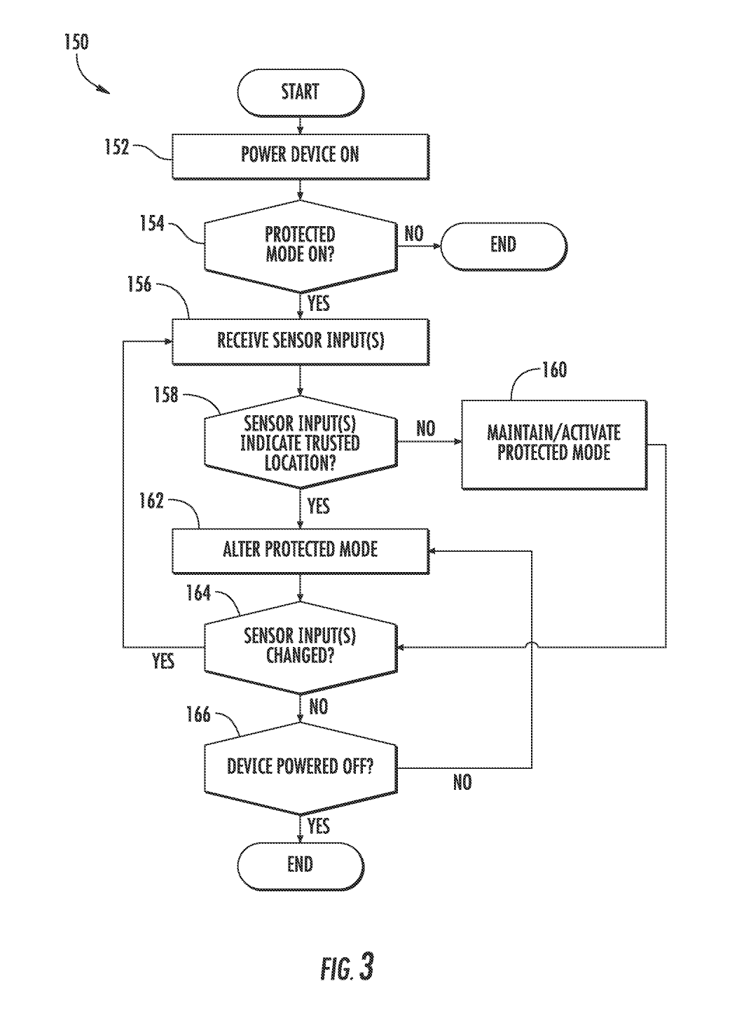

Referring to FIG. 3, an exemplary location aware locking method 150 is shown in which a trusted location can be determined with respect to an input received by the sensor 17 of the device 10. The method 150 illustrated in FIG. 3 may be applicable to the embodiments described above in relation to FIG. 1, but it is understood that the method 150 can be carried out with other suitable systems and arrangements. Moreover, the method 150 may include other steps that are not shown here, and in fact, the method 150 is not limited to including every step shown in FIG. 3. The steps that are illustrated here as part of the method 150 are not limited to this particular chronological order, either. The user can configure the device 10 in any suitable manner so that one or more parameters are identified as trusted locations.

In step 152, the mobile device 10 is powered on. In decision block 154, the mobile device 10 can determine whether the protected mode has been activated. If the protected mode has not been activated, then no further action may be taken. However, the device 10 may continuously, periodically or randomly return to decision block 154, as the user may subsequently activate the protected mode of the device 10.

If the protected mode is activated, then, in step 156, the sensor 17 of the device 10 can receive inputs. In decision block 158, the device 10 can compare the sensor inputs received in step 156 to the set of trusted parameters, as previously defined by the user. In this way, the device 10 can determine whether it is in a trusted location. Some examples of ways in which the device 10 can be configured to perform step/decision block 156 and 158 will now be described.

A trusted parameter can be defined in any suitable manner. For instance, a trusted parameter can be defined by a specific signal, which can have any type of identifying characteristics. In such case, the device 10 can consider itself to be in a trusted location as long as it receives a predetermined signal from a source, such as a beacon, transponder, NFC source or other suitable signal source. At step 156, the sensor 17 may detect such signals if it is located within a certain distance of the source. Such signals may be sent from the sources continuously or periodically.

At decision block 158, if the signal received in step 156 is not included in the predetermined set of signals, then the signal identified in step 156 is determined to be a non-trusted location. As a result, the protected mode of the device 10 can be maintained in step 160. In such case, the device 10 may continuously, periodically or randomly return to step 156, as the signals received by the sensor 17 may change. At decision block 158, if the signals received by the sensor 17 are included in the set of predetermined trusted signals, then the method can continue to step 162.

In another embodiment, the device 10 can emit signals from the transmitter 19. The signals can be transmitted continuously, periodically or randomly. In this way, the device 10 can act as a beacon. At step 156, the sensor 17 may, in some cases, receive a response to its signal from a transponder or other source. Such responsive signals may be generated if the device 10 is sufficiently proximate to a transponder. If a responsive signal is received, then the device 10 can determine at decision block 158 that it is located in a trusted location, and the method can continue to step 162.

In the either case (device 10 includes a transmitter 19 or does not include a transmitter 19), the device 10 can continue to operate in the altered protected mode until response signals from the transponder cease or are not received within an expected interval. If the sensor 17 does not receive a response from a transponder at decision block 158, then the protected mode can be maintained at step 160.

In another embodiment, the sensor 17 may be a contact-based sensor. Thus, when the device 10 is contacted, such contact can be detected by the sensor 17 at step 156. Certain contact may occur in a unique form, thereby providing an indication of the location of the device 10. For instance, when the device 10 is engage with a known docking station, the device 10 may contact the docking station in unique manner that may not otherwise occur, such as at specific locations or in a specific combination of locations. At decision block 158, if a predetermined contact profile is detected by the sensor the device 10, then the method 150 can continue to step 162.

As noted before, the sensor 17 can be configured to detect various forms of parameters or phenomena. For example, certain humidity, temperature or altitude levels can be detected, which may provide an indication that the device 10 is in a trusted or non-trusted location. As another example, certain wavelengths of light or frequencies of sound can be detected and compared to predetermined values to determine whether the device 10 is in a trusted location. Similarly, the sensor 17 can serve as a motion detector, and certain predetermined movements of the device 10 can provide an indication as to whether the device 10 is in a trusted location.

With any of the above parameters, values or configurations for the sensor 17, if the device 10 is determined to be a non-trusted location in decision block 158, the protected mode of the device 10 can be maintained in step 160. If the device 10 is determined to be in a trusted location in step 158, then the device 10 can alter the protected mode in step 162. The previous discussion of altering the protected mode in connection with step 112 of FIG. 2 above applies equally to step 162.

After step 160 or step 162, the device 10 can determine whether the sensor inputs have changed in decision block 164. Such a change may occur if signals cease being received by the sensor 17 or are not received within an expected period of time or if the contact profile has changed or if the received values are different from previous measurements. If the sensor 17 inputs have changed, then the method 150 can return to step 156 where the sensor 17 can receive new inputs. If the device 10 was previously located in a trusted location but has subsequently moved to a non-trusted location, then the protected mode can be restored at step 160; that is, the altered protected mode can be discontinued and the standard setting for the protected mode can be implemented.

If the sensor inputs have not changed, then the device 10 can continue to decision block 166, where it is determined whether the device 10 has been powered off. If the device 10 is still powered on, the method can return to step 162, where the protected mode can continue to be implemented in its altered form. Powering off the device 10 in step 166 can terminate the method 150.

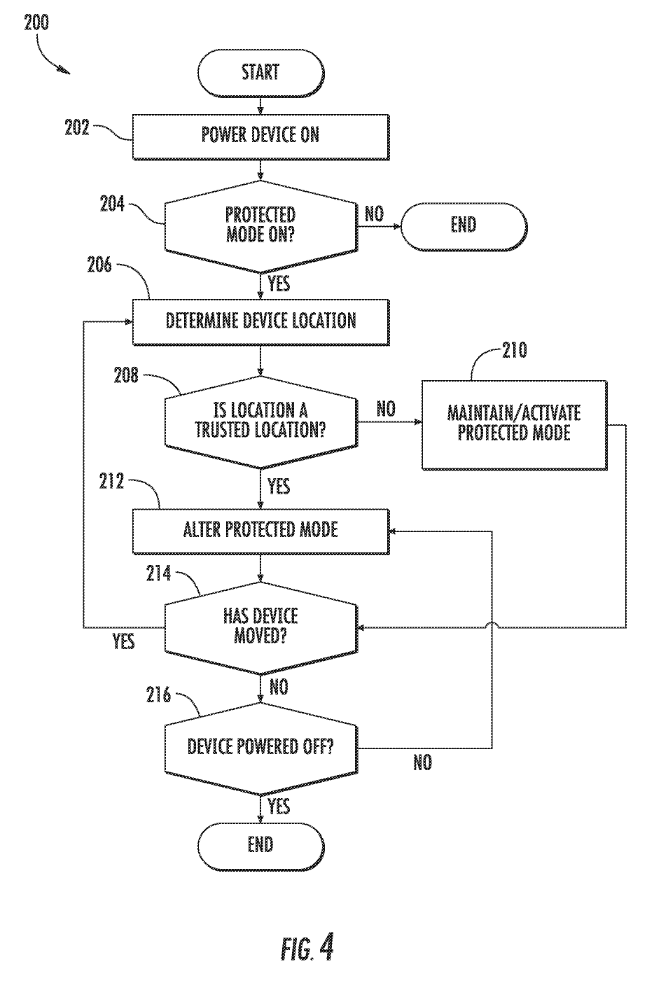

In another embodiment, the trusted location can be defined by a specific geographic location. Referring to FIG. 4, an exemplary location aware locking method 200 is shown in which a trusted location is defined by a specific geographic location. The method 200 illustrated in FIG. 4 may be applicable to the embodiments described above in relation to FIG. 1, but it is understood that the method 200 can be carried out with other suitable systems and arrangements. Moreover, the method 200 may include other steps that are not shown here, and in fact, the method 200 is not limited to including every step shown in FIG. 4. The steps that are illustrated here as part of the method 200 are not limited to this particular chronological order, either. The user can configure the device 10 in any suitable manner so that a set of specific geographic locations is identified as trusted locations. The set can include one or more geographic locations.

A trusted geographic location can be defined in any suitable manner. For instance, a trusted geographic location can be defined by geographic coordinates, a specified radius about geographic coordinates or an area defined by geographic coordinate boundaries. The user can manually input one or more geographic coordinates into the device 10 to be considered as trusted locations. The user can input the trusted geographic location in any suitable manner, including by using the user input interface 20.

In step 202, the mobile device 10 is powered on. In decision block 204, the mobile device 10 can determine whether the protected mode has been activated. If the protected mode has not been activated, then no further action may be taken. However, the device 10 may continuously, periodically or randomly return to decision block 204, as the user may subsequently activate the protected mode of the device 10.

If the protected mode is activated, then, in step 206, the device 10 can determine its location using the positioning system 18. In step 208, the device 10 can compare the location determined in step 206 to the set of trusted geographic locations, as previously defined by the user. In this way, the device 10 can determine whether it is in a trusted geographic location. If the position of the device 10, as determined by the positioning system 18, is not included in the predetermined set of trusted geographic locations, then the geographic location determined in step 206 is determined to be a non-trusted geographic location. As a result, the protected mode of the device 10 can be maintained in step 210. If the position of the device 10 is in a trusted geographic location, however, then the device 10 can alter the protected mode in step 212. The previous discussion of altering the protected mode in connection with step 112 of FIG. 2 above applies equally to step 212.

After step 210 or step 212, the device 10 can determine whether it has moved in decision block 214. If the device 10 has moved, then the method can return to step 206 where the positioning system 18 determines the new position of the device 10. If the device 10 was previously located in a trusted geographic location but has subsequently moved to a non-trusted geographic location, then the protected mode can be restored at step 210, that is, the altered protected mode can be discontinued and the standard setting for the protected mode can be implemented. Any suitable method can be used to determine whether the device 10 has moved, including the intermittent retrieval of location information from the positioning system 18.

If the device 10 has not moved, then the device 10 can continue to decision block 216, where it is determined whether the device 10 has been powered off. If the device 10 is still powered on, the method can return to step 212, where the protected mode can continue to be implemented in its altered form. Powering off the device 10 in decision block 216 can terminate the method 200.

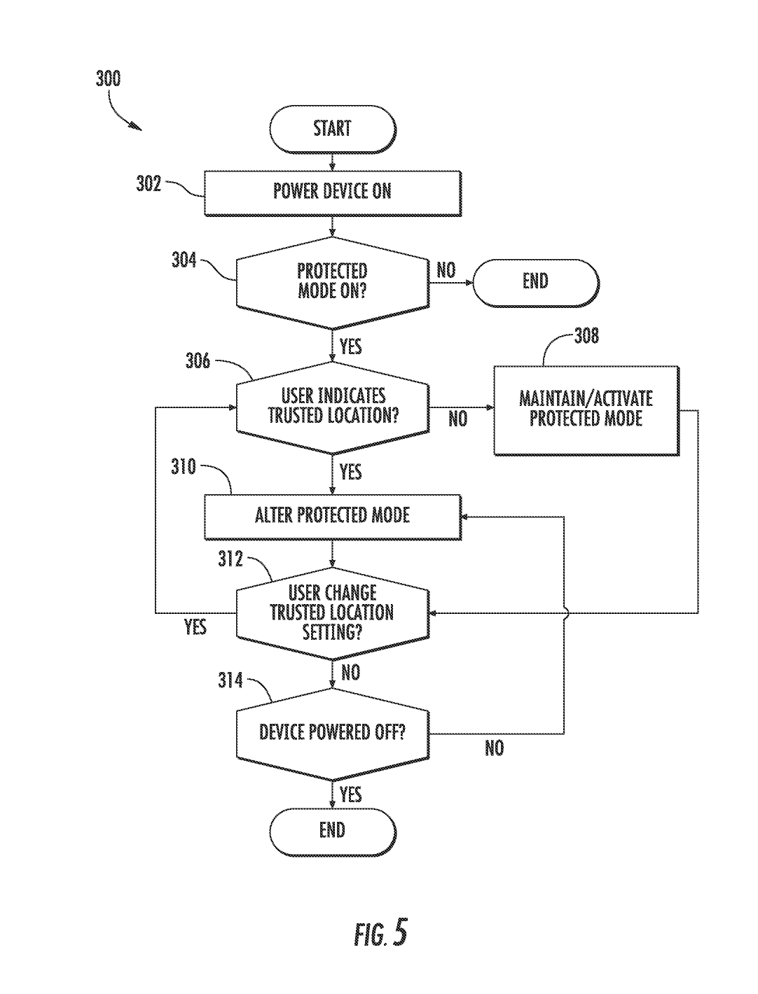

Referring to FIG. 5, an exemplary location-based self-locking method 300 is shown in which a trusted location is defined by a direct setting by the user. The method 300 illustrated in FIG. 5 may be applicable to the embodiments described above in relation to FIG. 1, but it is understood that the method 300 can be carried out with other suitable systems and arrangements. Moreover, the method 300 may include other steps that are not shown here, and in fact, the method 300 is not limited to including every step shown in FIG. 5. The steps that are illustrated here as part of the method 300 are not limited to this particular chronological order, either.

In step 302, the mobile device 10 can be powered on. In decision block 304, the mobile device 10 can determine whether the protected mode has been activated. If the protected mode has not been activated, then no further action may be taken. However, the device 10 may continuously or periodically return to decision block 304, as the user may subsequently activate the protected mode of the device 10.

If the protected mode is activated, then, in step 306, the device 10 can determine whether the user has indicated that the device 10 is in a trusted location. If the user has not indicated that the device 10 is in a trusted location, then the protected mode of the device 10 can be maintained in step 308 (or activated if operating in an altered protected mode as discussed below). If the user has indicated that the device is in a trusted location, then the device 10 can alter the protected mode in step 310. The previous discussion of altering the protected mode in connection with step 112 of FIG. 2 above applies equally to step 310.

After step 308 or step 310, the device 10 can determine whether the user has changed the trusted location setting at decision block 312. Step 312 can occur in various ways. For instance, the device 10 can prompt the user as to whether the device 10 is still located in a trusted location. Such prompting may occur after a certain amount of time has elapsed or upon the occurrence of a predetermined condition. Alternatively, the device 10 may await an input from the user.

If the trusted location setting has changed, then the method can return to decision block 306 where the device 10 can determine if it is still located within a trusted location. If the user previously indicated that the device 10 was located in a trusted location but has subsequently indicated that the device 10 is not within a trusted location, then the protected mode can be activated at step 308. If the user has not changed the trusted location setting, then the device 10 can continue to decision block 314, where it is determined whether the device 10 has been powered off. If the device 10 is still powered on, the method 300 can return to step 310, where the protected mode can continue to be implemented in its altered form. Powering off the device 10 in step 314 can terminate the method 300.

In any of the implementations described herein, the device 10 can be configured such that the set of trusted locations can be learned by the device 10. For example, the device 10 may be in a non-trusted area by default, as the user has not predefined the present location (as defined by a network, WAP, parameter, geographic location, etc.) as being a trusted location. Accordingly, the protected mode of the device 10 would be activated, and the device 10 may automatically lock itself after a period of inactivity. If sufficient authentication is provided to unlock the device 10, the user may be prompted by the device 10, such as being presented with a dialogue box, requesting user input on whether the current location should be considered a trusted location. If the user indicates that the present location is a trusted location, then the present location can be added to the set of trusted locations.

Thus, it will be appreciated that by altering the protected mode of the device 10 when the device is located in a trusted location, as described above, the need for a user to frequently unlock the device 10 after a period of inactivity can be minimized. As a result, it will be appreciated that the user's annoyance and frustration can be reduced.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Aspects herein can be embodied in other forms without departing from the spirit or essential attributes thereof. Accordingly, reference should be made to the following claims, rather than to the foregoing specification, as indicating the scope of the invention.

What is claimed is:

1. A method for operating a mobile device in a trusted location, the mobile device having a processor, the mobile device including a protected mode in which the device automatically locks itself after a period of inactivity and an unprotected mode in which the device does not lock itself, wherein when the device is in the protected mode, the method comprising:
determining whether the device is in a trusted location; and
altering the protected mode of the device if the device is determined to be in a trusted location.

2. The method of claim 1, wherein the trusted location is defined by a predetermined set of one or more trusted networks, and wherein the determining step includes the steps of:
identifying a network to which the device is connected;
comparing the identified network to the predetermined set of trusted networks, wherein, if the identified network is included in the predetermined set of trusted networks, then the device is determined to be in a trusted location.

3. The method of claim 1, wherein the trusted location is defined by a predetermined set of one or more trusted wireless access points, and wherein the determining step includes the steps of:
identifying a wireless access point to which the device is operatively connected;
comparing the identified wireless access point to the set of predetermined trusted wireless access points, wherein, if the identified wireless access point is included in the predetermined set of trusted wireless access points, then the device is determined to be in a trusted location.

4. The method of claim 1, wherein the device includes a positioning system, wherein the trusted location is defined by a predetermined set of one or more trusted geographic locations, and wherein the determining step includes the steps of:
determining the geographic location of the device via the positioning system;
comparing the determined geographic location of the device to the predetermined set of trusted geographic locations, wherein, if the determined geographic location is within the predetermined set of trusted geographic locations, then the device is determined to be in a trusted location.

5. The method of claim 1, wherein the trusted location is defined by a user input, and wherein the determining step includes the step of determining whether a user has indicated that the device is in a trusted location.

6. The method of claim 1, wherein the device further includes a sensor configured to detect unidirectional signals, wherein the trusted location is defined by a predetermined set of one or more trusted unidirectional signals, and wherein the determining step includes the steps of:
comparing a unidirectional signal received by the sensor to the predetermined set of trusted unidirectional signals, wherein, if the received unidirectional signal is included in the predetermined set of unidirectional trusted signals, then the device is determined to be in a trusted location.

7. The method of claim 1, wherein the device further includes a transmitter for transmitting signals and a sensor configured to detect signals responsive to said signals from the transmitter, and further including the steps of:
transmitting a signal from the transmitter;
comparing a signal received by the sensor in response to the signal in the transmitting step to a predetermined set of one or more trusted signals, wherein, if the received signal is included in the predetermined set of trusted signals, then the device is determined to be in a trusted location.

8. The method of claim 1, wherein the device includes a sensor configured to detect a physical contact with the device, wherein the trusted location is defined by a predetermined set of one or more trusted physical contact conditions, and wherein the determining step includes the steps of:
via the sensor, detecting physical contact with the device;
comparing the detected physical contact with the device to the predetermined set of trusted physical contact conditions, wherein, if the detected physical contact with the device is included in the predetermined set of trusted physical contact conditions, then the device is determined to be in a trusted location.

9. The method of claim 1, wherein the altering step includes disabling the protected mode of the device.

10. The method of claim 1, wherein the altering step includes changing a parameter of the protected mode of the device.

11. The method of claim 10, wherein the parameter is the period of inactivity that causes the device to automatically lock itself, wherein the step of changing a parameter includes increasing the period of inactivity.

12. A device including a protected mode in which the device automatically locks itself after a period of inactivity and an unprotected mode in which the device does not lock itself, the device comprising:
a processor configured to:
determine whether the device is in a trusted location; and
alter the protected mode of the device if the device is determined to be in a trusted location.

13. The device of claim 12, wherein the trusted location is defined by a predetermined set of one or more trusted networks, and wherein the processor is configured to:
identify a network to which the device is connected; and
compare the identified network to the predetermined set of trusted networks, wherein, if the identified network is included in the predetermined set of trusted networks, then the device is determined to be in a trusted location.

14. The device of claim 12, wherein the trusted location is defined by a predetermined set of one or more trusted wireless access points, and wherein the processor is configured to:
identify a wireless access point to which the device is operatively connected; and
compare the identified wireless access point to the set of predetermined trusted wireless access points, wherein, if the identified wireless access point is included in the predetermined set of trusted wireless access points, then the device is determined to be in a trusted location.

15. The device of claim 12, wherein the device includes a positioning system, wherein the trusted location is defined by a predetermined set of one or more trusted geographic locations, and wherein:
the positioning system is configured to determine the geographic location of the device; and
the processor is configured to compare the determined geographic located of the device to the predetermined set of trusted geographic locations, wherein, if the geographic location determined by the positioning system is within the predetermined set of trusted geographic locations, then the device is determined to be in a trusted location.

16. The device of claim 12, wherein the trusted location is defined by a user input, and wherein the processor is configured to determine whether a user has indicated that the device is in a trusted location.

17. The device of claim 12, wherein, in the altering step, the processor is configured to alter the protected mode by disabling the protected mode of the device or by changing a parameter of the protected mode.

18. The device of claim 12, wherein the device further includes a sensor for detecting signals, wherein the trusted location is defined by a predetermined set of one or more trusted signals, wherein, if a signal received by the sensor is included in the predetermined set of trusted signals, then the device is determined to be in a trusted location.

19. The device of claim 12, wherein the device further includes a transmitter for transmitting signals and a sensor configured to detect signals responsive to said signals from the transmitter, and wherein, if a signal received by the sensor is included in a predetermined set of one or more trusted signals, then the device is determined to be in a trusted location.

20. The device of claim 12, wherein the device further includes a sensor configured to detect physical contact with the device, wherein, if physical contact with the device is detected by the sensor and the physical contact is included in a set of one or more trusted physical contact conditions, then the device is determined to be in a trusted location.
